(19) United States
(12) Patent Application Publication
(10) Pub. No.: US 2012/0107221 A1
(43) Pub. Date: May 3, 2012

(54) METHOD FOR THE SYNTHESIS OF CARBON NANOTUBES ON LONG PARTICULATE MICROMETRIC MATERIALS

(75) Inventor: Jinbo Bai, Anthony (FR)

(73) Assignee: CENTRE NATIONAL DE LA RECHERCHE SCIENTIFIQUE - CNRS -, Paris Cedex 16 (FR)

(21) Appl. No.: 13/133,294

(22) PCT Filed: Dec. 4, 2009
(86) PCT No.: PCT/FR2009/052409

§ 371 Date: Jan. 18, 2012

(30) Foreign Application Priority Data
Dec. 8, 2008 (FR) 08/06869

(51) Int. Cl. D01F 9/127; B05D 3/04; B82B 1/00; B82B 3/00

(52) U.S. Cl. 423/447.2; 427/227; 977/742; 977/843

(57) ABSTRACT

The invention relates to a method for the synthesis of carbon nanotubes on the surface of a material. The invention more particularly relates to a method for the synthesis of carbon nanotubes (or CNT) at the surface of a material using a carbon source comprising acetylene and xylene, and a catalyst containing ferrocene. The method of the invention has the advantage, amongst others, of enabling the continuous synthesis of nanotubes when desired. Also, the method of the invention is carried out at temperatures lower than those of known methods and on materials on which the growth of carbon nanotubes is difficulty reproducible and/or difficulty homogenous in terms of CNT diameter and density (number of CNT per surface unit). Said advantages, amongst others, make the method of the invention particularly useful at the industrial level. The invention also relates to materials that can be obtained by said method and to the use thereof in all the known application fields of carbon nantubes, in particular as a reinforcement for preparing structural and functional composite materials.

### TECHNICAL FIELD

The present invention relates to a method for the synthesis of carbon nanotubes on the surface of a material.

More particularly, the invention relates to a method for the synthesis of carbon nanotubes (or CNT) at the surface of a material using a carbon source comprising acetylene and xylene, and a catalyst containing ferrocene. The method of the invention has the advantage, inter allia, of enabling the “continuous” synthesis of nanotubes when desired. Also, the method of the invention is carried out at temperatures lower than those of known methods and on materials on which the growth of carbon nanotubes is difficulty reproducible and/or not readily homogenous in terms of CNT diameter and density (number of CNT per surface unit). These advantages, amongst others, make the method of the invention particularly useful at the industrial level.

The invention also relates to materials that can be obtained by this method and to the use thereof in all the known application fields of carbon nanotubes, in particular as a reinforcement for example for preparing structural and functional composite materials.

In the description below, the reference between brackets [ ] refers to the list of reference presented at the end of the text.

2. Related Art

The carbon nanotubes (CNT) generate much interest in the both fundamental and applied research circle as their properties are exceptional in many respects. From a mechanical point of view, the CNT have at the same time excellent rigidity comparable to that of steel, while being extremely lightweight (6 times lighter than steel). The CNT also have a good thermal and electric conductivity. According to their structure, the CNT may be conductive or semi-conductive.

The CNT have already been proposed as reinforcements in composite materials.

Within the framework of the invention, by “composite material” is meant a material constituted of at least two constituents. One is “the matrix” which ensures the cohesion of the composite. The other is the “reinforcement” or “backing” which ensures the composite interesting physical and mechanical qualities.

Despite the very interesting properties of the CNT, to this day, their use to reinforce the structures of composite material has proved unsatisfactory. In fact, little or no improvement on the mechanical properties of the composite material as for example the tensile, flexion, and compression strengths, rigidity and life span, lightening of the specific weight, corrosion resistance has been obtained. Moreover, the improvement of the properties of electric and/or thermal conductivity has been insufficient. This may be explained for example by the damage of the CNT or of their properties during the dispersion of the CNT, by the wrong dispersion or alignment in the matrix of the composite material, by the high contact strength between the CNT and/or between the CNT and their environment (matrix, substrates, etc.) by the addition of surfactants/dispersants, by an insufficient interface between the CNT and the matrix, or even, by the use of a high ratio of CNT.

An alternative consists in using conventional reinforcements such as for example the particles and fibers of silicon carbide (SIC), of alumina (Al₂O₃), of carbon fibers, at the surface of which the carbon nanotubes (CNT) are synthesized. Within the framework of the invention, the terms “synthesize”, “deposit” or even “make grow” may be used to designate the same phenomenon, namely, synthesizing CNT which are directly deposited at the surface of the material/reinforcement.

To this day, the existent methods for synthesizing/growingow NCT at the surface of reinforcements are not fully satisfactory for at least any one of the following reasons:
the known methods are not always adapted for the processing of reinforcements of variable geometry (short fiber, long or continuous fiber, particles etc.) in large quantities and/or “continuously” and particularly require the interruption of the production when one wishes to renew the reinforcements to process (case of short particles and fibers) and/or keep the integrality of the reinforcements (case of long fibers) rendering their industrial use prohibitive;
the existent methods do not allow for homogeneity particularly in diameter, in density (number of CNT per surface unit) and in arrangement of the deposited CNT. This homogeneity may affect the quality of the interface between the CNT's and the reinforcement and thus the quality and properties of the composites;
the test conditions such as for example the temperature, the nature and/or the quantity of chemical precursors used in certain methods may not be suitable for all types of reinforcements used thus resulting in the damage of certain reinforcements;
the toxic and/or pollutant nature of certain chemical precursors used may sometimes make certain methods non industrializable;
the methods are not always reproducible.

Thus, there exists a real need for a method for synthesizing carbon nanotubes (CNT) at the surface of a material, particularly a material which may be used as a reinforcement, for example in composite materials, overcoming the defects, drawbacks and obstacles of the prior art.

More particularly, there is a real need for a method for the synthesis of carbon nanotubes at the surface of a material, particularly a material that may be used as a reinforcement, for example in composite materials, which is reproducible, industrially realizable and economically interesting and avoids having recourse to toxic and pollutant chemical precursors.

In addition, there is a real need for a method for the synthesis of carbon nanotubes at the surface of a material, particularly a material which may be used as a reinforcement, for example in composite materials:
which may be suitable for the different types and geometries of materials/reinforcements to process (short and long fibers, particles, etc.);
which allows an homogeneity, particularly in diameter, in density and in arrangement of deposited CNTS;
which allows to modulate the parameters of the method in order to adapt the homogeneity, diameter and the density of the CNT to the aimed application;
which does not damage the material/reinforcement at the surface of which the CNT are to be deposited.

Furthermore, there is a real need for a method for the synthesis of CNT at the surface of a material;
which leads to a material/reinforcement comprising at its surface, NTC's usable directly for example for preparing structural composites, or
which is compatible with any eventual processing of the material/reinforcement at the surface of which the CNT have been deposited, for example when one wishes to reinforce the adhesion of the CNT on said material/reinforcement.

### DESCRIPTION OF THE INVENTION

The precise aim of the present invention is to meet this need by providing a method for the synthesis of carbon nanotubes (CNT) at the surface of a material, comprising the following steps carried out under a stream of inert gas(es) optionally mixed with hydrogen:

(i) heating the material in a reactor, at the surface of which the carbon nanotubes are to be synthesized, at a temperature ranging from 350° C. to 850° C., for example from 400 to 780° C.;

(ii) introducing in said reactor, a carbon source comprising acetylene and xylene, and a catalyst containing ferrocene;

(iii) exposing the heated material to the carbon source and the ferrocene-containing catalyst for a duration sufficient for obtaining carbon nanotubes at the surface of said material;

(v) recovering, optionally after cooling, the material comprising at its surface carbon nanotubes, at the end of step (iii).

Within the meaning of the present invention, what is meant by “nanotubes” is a carbon-based tubular structure, which has a diameter ranging between 0.5 and 100 nm. These components belong to the family called “nanostructured material”, which have at least a nanometric characteristic dimension. For more details pertaining to these materials and their mode of synthesis, the paper “nanotubes from carbon” by P. M. Ajayan [1] may be referred to.

Within the framework of the present invention, the terms “material”, “reinforcement” or “material/reinforcement” are used indifferently to designate a material which may be used for example to ensure the composite materials physical and mechanical properties such as for example the tensile, flexion, and compression strengths, rigidity and life span, lightening of the specific weight, corrosion resistance, electric and/or thermal conductivity and shielding of electromagnetic waves etc.

The method of the invention has the advantage of being suitable for all types of material, whatever the structure is: short, long or continuous fibers, particles. Within the context of the invention, a fiber is called “long or continuous” when its length is equal to or higher than 10 cm and a fiber is called short when its length is lower than 10 cm.

The method may be similar when CNT are to be synthesized at the surface of the particles and short fibers.

The method of the invention is more particularly suitable for long or continuous fibers.

The catalyst may exclusively comprise ferrocene. It may also comprise ferrocene possibly in a mixture with another catalyst selected from the organometallic group comprising the phthalocyanine and the iron pentacarbonyl.

The reactor may be any device allowing for a simultaneous and monitored introduction of chemical precursors, provided with at least an oven with a gas circulation system and at least a gas and liquid flowmeter making it possible to measure and monitor the flow of gases and liquids. Examples of devices which may be suitable for the implementation of the method of the invention are indicated in FIGS. 1, 2 and 3.

The material in step (i) may be in the form of fibers of a diameter of 1 to 100 nm, more particularly of 4 to 50 nm, or particles of a diameter of 0.1 to 100 nm, more particularly of 0.4 to 50 nm.

In a particular embodiment of the invention, in step (i), the material is in the form of long fibers, such as previously defined, with a diameter of 4 to 50 nm.

The method of synthesizing the CNT according to the invention has the advantage of being implemented continuously. By continuous synthesis method is meant a method in which the introduction of the material/reinforcements at the surface of which the CNT are to be synthesized, does not require the shutting off of equipment nor the stopping of the production.

A continuous method is particularly interesting in the case where the material to process is a long fiber as defined previously.

The material to process is selected amongst those that are able to withstand the deposit temperature of the CNT.

The material in step (i) is selected from the group comprising:
fibers of carbon, glass, alumina, silicon carbide (SiC), rock;
ceramic materials selected from the group comprising particles and fibers of silicon nitride (Si₃N₄), boron carbide (B₄C) silicon carbide (SiC), titanium carbide (TiC), cordierite (Al₃Mg₂AlSi₅O₁₈), mullite (Al₆Si₂O₁₃), aluminium nitride (AIN), boron nitride (NB), alumina (Al₂O₃), aluminium boride (AlB₂), magnesium oxide (MgO), zinc oxide (ZnO), magnetic iron oxide (Fe₃O₄), zirconia (Zr₂O), silica (Si₂O), silica fume, CaO, La₂CuO₄, La₂NiO₄, La₂SrCuO₄, Nd₂CuO₄, TiO₂, Y₂O₃, aluminium silicates (clays).

The improved performances of the method of the invention may be explained by implementing the specific combination: acetylene, xylene and ferrocene. By modifying the physical parameters of these chemical precursors (the temperature, gas flowrate etc.), a method is obtained which may be suitable for the processing of any type of reinforcement and which also allows for monitoring the morphology particularly the diameter, density and arrangement of the deposited CNTs.

A few of the unexpected advantages of the method of the invention linked to the use of acetylene and xylene as carbon sources in conjunction with ferrocene as an iron-based catalyst, may be summarized as follows:

1. The simultaneous use of acetylene and xylene as a carbon source and the adaptation of their flowrate, allows for homogeneity particularly in diameter and in arrangement of the CNT synthesized at the surface of the reinforcements and the number of CNT per surface unit. By arrangement of the CNT, is meant the spatial arrangement (for example the growth angle) of the CNT and/or the surface homogeneity of the deposit of the CNT.

2. The use of a carbon source constituted of acetylene in combination with xylene makes it possible to obtain a growth of the CNT on the reinforcements with a greater homogeneity in diameter and density (number of CNT per μm²) than with a carbon source constituted solely with xylene or acetylene. For example, it has been observed that the carbon fibers are processed in the entire thickness and length of the strand and that the particles, for example the ceramic particles, when they are in the form of powder, are processed better in the powder mass deposited in the reactor. This homogeneity in diameter and in density is very important for the quality and properties of the composites comprising these reinforcements. This homogeneity is much greater than, for example, the combination of xylene and ferrocene, advocated by numerous studies [2].

3. The combination of xylene and acetylene as carbon source also makes it possible to synthesize the CNT at a lower temperature than with xylene alone (for example from 350° C. instead of 750° C. to 810° C. with xylene), which allows for example the grafting of glass fibers (SiC₂) without damaging them. Furthermore, it has been observed that when the carbon source is constituted of acetylene and xylene, the concentration in benzene and/or toluene (toxic) emitted is substantially lesser than with the methods not using xylene. In certain cases this emission may be null.

4. The use of ferrocene as catalyst, in association with xylene and acetylene, has the advantage of decreasing the risk of damaging the mechanical properties of materials particularly carbon and glass fibers, with respect to nickel-based catalyst advocated by different studies of growth of CNT on carbon or glass fiber, and thus at higher deposit temperatures and longer processing times. According to a recent study, the mechanical resistance of processed fibers has dropped by 50% after the growth processing of CNT [4].

The use of ferrocene further makes it possible to avoid the recourse to components of known toxicity. In fact, it has been shown that the nickel and cobalt nanoparticles are satisfactory catalysts [3] but whereof the toxicity is proven.

In step (ii), the acetylene is introduced in the reactor in the form of gas with a linear velocity of 5.0×10⁻⁶ to 1.0×10⁻¹ m/s, more particularly 1.0×10⁻⁵ to 5.0×10⁻³ m/s. “linear velocity” means the distance covered by the acetylene in 1 second. The linear velocity is determined according to the flowrate of acetylene and the volume of the reactor. For example, for a tube of internal diameter of 45 mm, a gas flowrate of 1 l/min corresponds to a linear velocity of 0.0095 m/s. This holds true for all gases used within the framework of the present invention.

The acetylene is introduced in a quantity higher than 0 and able to reach up to 20 vol. % of the total gas. It may even be introduced for example in a quantity ranging from 0.1 to 10 vol. % of total gas.

In step (ii), the xylene is introduced in the reactor under liquid form possibly in a mixture with the ferrocene.

When the ferrocene is introduced by vaporization (FIG. 2a), the xylene is introduced on its own.

The system used for the introduction of xylene, on its own or mixed with the ferrocene, may be any system allowing for its injection for example an atomizer, a vaporizer, a nebulizer or an aero-mist sprayer.

The flowrate of xylene, on its own or mixed with the ferrocene, may be comprised between 5 and 40 ml/h, for example between 10 and 25 ml/h for a CVD tube of a diameter of around 45 mm.

An advantage of an independent introduction of ferrocene and the carbon source is the possibility to choose the moment for introducing one with respect to the other and the relative quantity of one with respect to the other.

According to a particular embodiment of the invention, the xylene is introduced under liquid form mixed with the ferrocene. This allows for bringing an interesting technical solution for introducing the ferrocene, by dissolving it with liquid xylene, for a synthesis in presence of acetylene.

The ferrocene content in this mixture ranges between 0.001 to 0.3 g of ferrocene/ml of xylene, for example between 0.001 and 0.2 g of ferrocene/ml of xylene, more particularly between 0.01 and 0.1 g of ferrocene/ml of xylene. The xylene/ferrocene mixture may then be introduced with a flowrate of 0.1 to 20 ml/h.

As previously indicated in step (ii) the ferrocene may also be introduced on its own in the reactor. In this case, prior to its introduction, the ferrocene is vaporized and it is the vapor of ferrocene that is introduced into the reactor for example by the gas flow for example of argon.

In step (iii); the heated material is exposed to the carbon source and to the catalyst for 1 to 120 minutes. This duration may even be of 5 to 90 minutes, for example of 5 to 30 minutes.

The skilled person will know how to adapt this duration according to on the one hand the size and density of the sought CNT and on the other hand the material and the degradation hazard of said material during processing.

In step (iv), the material obtained from step (iii), which comprises at its surface CNT, may be recovered without any prior cooling, for example at the output of the reactor when the synthesis is “continuous”, or is recovered after cooling for example at a temperature of 15 to 35° C.

All steps (i) to (iv) are carried out under a stream of inert gas(es) possibly mixed with hydrogen with a hydrogen/inert gas(es) ratio of 0/100 to 50/50, for example of 0/100 to 40/60.

Inert gases may be selected from the group comprising helium, neon, argon, nitrogen and krypton.

Implementing the prior dispositions makes it possible by monitoring the growth of the CNT at the surface of the material/reinforcement, to improve particularly the interface properties between the CNT and the reinforcements and the composite properties by ensuring a good dispersion of the CNT in the matrix.

Resulting from step (iv), the material comprising at its surface carbon nanotubes may be used as it is in the different considered applications.

Alternatively, for applications requiring a particularly strong bond between the CNT and the material/reinforcement, it is possible to provide an additional step wherein either one applies a thermal processing allowing to create nanoweldings between the CNT and the material/reinforcement or a deposit of biocompatible conductive polymer on the material obtained in step (iv) is carried out.

According to this alternative, when it comes to biocompatible conductive polymer on long fibers, the deposit of the polymer will be carried out continuously, for example in the zones indicated in FIGS. 2a (18) and 2b (17).

Thus, the adhesion of the CNT on the materials/reinforcements is enhanced and consolidated further. This reinforcement operation contributes to the safety and protection of the users and consequently the constraints linked to hygiene and safety are reduced. It also prevents the possible detaching of the CNT which may occur during the manipulation, the use and the transport of said reinforcements for the preparation of materials, for example large-scale composite materials and their direct use.

In addition, the deposit of a biocompatible conductive polymer on the material obtained in step (iv), makes it possible to obtain a material/reinforcement which can ensure the end material for example the composite material a higher conductivity level, for example a conductivity level equal to or higher than 0.1 S/cm.

Several ways are possible particularly for fiber manufacturers, for depositing a polymer layer at the surface of the materials comprising CNT at their surface. One of these ways is the use of a standard sizing, in general epoxy, polyurethane or polyvinylpyrrolidone (PVP). A drawback of this way is that it interposes an insulating electric layer between the reinforcement comprising at its surface CNT and the environment in which it happens to be, for example the matrix of the composite material, thus increasing the contact strength of the reinforcement thus resulting in a decrease of electric and thermal conductivity of the end materials.

A promising alternative for the achievement of this additional step is thus the deposit of a layer of biocompatible conductive polymers on the material obtained in step (iv). The biocompatible conductive polymer may be an electrically conductive polymer (ECP) and/or a thermally conductive polymer (TCP). This step provides the material obtained in step (iv), with new multifunctional properties such as for example electric, thermal, optical and electromagnetic properties, etc.

Amongst the family of biocompatible conductive polymers, one may for example cite polyacetylenes, polypyrroles, polythiophenes, polyanilines and the polyvinyl paraphenylenes. The biocompatible conductive polymer may, furthermore be functionalized for a given matrix.

The invention also relates to the material comprising at its surface carbon nanotubes (CNT) that may be obtained by a method according to the invention.

The material comprising at its surface CNT that may be obtained by a method according to the invention may be in the form of short fibers (with a length less than 10 cm), long or continuous fibers (with a length equal to or higher than 10 cm), or even in the form of particles.

The material or reinforcement obtained according to the method of the invention has on its surface CNT and thus, with a good and reproducible homogeneity in diameter and in density (expressed particularly in number of CNT per μm²). Thus, the number of CNT per μm² at the surface of the material/reinforcement of the invention may be comprised between 5 and 200 per μm2, for example, between 30 and 60 per μm².

Generally, the material of the invention has a mass increase due to the deposit of the CNT, comprised between 0.2 and 80% with respect to the mass of the starting material. When the material of the invention is in the form of fibers, the mass increase is more particularly comprised between 0.2 and 10%, for example between 0.5 and 5% with respect to the mass of the starting material. When the material of the invention is in the form of particles, the mass increase is more particularly comprised between 5 and 50%, for example between 10 and 40% with respect to the mass of the starting material.

The material of the invention may also present a specific surface higher than 150 m²/g, for example, comprised between 150 and 2000 m²/g, for example between 200 and 1000 m²/g. In the present description, the term “specific surface” refers to the BET specific surface, such as determined by the adsorption of nitrogen, according to the well known method called BRUNAUER-EMMET-TELLER which is described in the journal of the American Chemical Society, volume 60, page 309 51938 and corresponding to the ISO 5794/1 international standard.

The invention also includes material which comprises at its surface carbon nanotubes (CNT) that may be obtained by a method according to the invention, and a biocompatible conductive polymer deposited at the surface of the CNT.

The materials/reinforcements according to the present invention may be used in all applications where such material/reinforcements are implemented. They are more particularly used as reinforcements for the preparation of composite materials, particularly in fields where their electric properties are sought and/or in fields where their mechanical properties are sought.

The composite materials comprising materials/reinforcements of the invention, may be intended for example for the automobile industry, the aeronautical and spatial industry, sports equipment or even for electronic equipment.

They can also be used for the preparation of electrochemical components particularly the large surface electrode for its great corrosion resistance.

They make it possible to obtain the particular structure of filtration and/or decontamination materials particularly for air, wastewater, and gases at high temperature.

Due to the biocompatible characteristic of carbon, the materials/reinforcements of the invention may particularly be employed for the preparation of biomaterials and protheses.

Considering its high specific surface, the material according to the invention may be used for the preparation of catalyst supports, for example for heterogenous catalysts.

Furthermore, it can be used for preparing fabrics or high performance clothing.

Finally, when the material of the invention is riot in the form of long fibers such as defined previously, it may be used as reinforcement for the preparation of paints and varnishes.

Other advantages may become apparent to the skilled person upon reading the examples below, illustrated by the accompanying drawings.

### BRIEF DESCRIPTION OF THE FIGURES

FIG. 1 represents the diagram of an assembly used for the synthesis of carbon nanotubes on long and particulate reinforcements (long fibers) according to the invention. The different parts of this assembly are:
1 represents the synthesis area
2 represents the preparation area: preheating, decomposition, mixture and homogenization of gases,
3 represents the heating tube ensuring the transit of vapor of ferrocene without condensation,
4 represents the reactor for vaporizing the ferrocene,
5 represents the reactor containing the mixture of xylene and ferrocene
6 represents the reactor containing the xylene
7 represents 3 digital mass flowmeters monitoring the flow of argon, acetylene and hydrogen.
8 represents a quartz tube,
9 represents the oven n.1,
10 represents the oven n.2.

FIG. 2a represents the diagram of an assembly used for the continuous synthesis of carbon nanotubes on fibers. In this assembly, ferrocene is used on its own and, is vaporized beforehand on its introduction. The different parts of this assembly are:
1 represents the commercial coils of fiber,
2 represents the circulation area in which the fibers circulate and are able to make up to 4 return cycles or more,
3 represents the lock, provided with a cap and inputs-outputs provided for the fibers and the injection of inert gas,
4 represents the oven 1,
5 represents the coil of processed and stored fibers,
6 represents the containment enclosure,
7 represents the reeling system which particularly enables to correctly wind fibers into coils while respecting the coil pitch,
8 represents the device for injecting the ferrocene in vapor phase in presence of the argon (Ar),
9 represents the pipe enabling to inject the ferrocene vapor “continuously” without condensation,
10 represents the processing or synthesis area,
11 represents 3 digital mass flowmeters monitoring the flowrates of argon (Ar), hydrogen (H2), and acetylene (C2H2),
12 represents the oven 2,
13 represents the cap,
14 represents the system for the atomization of xylene,
15 represents the syringe pump system and the xylene tank,
16 represents the CVD reactor for example of quartz tube,
17 represents the atomized liquid,
18 represents the area for the continuous deposit of a biocompatible conductive polymer.

FIG. 2b represents the diagram of an assembly used for the continuous synthesis of carbon nanotubes on fibers. In this assembly, the ferrocene is used mixed with xylene. The ferrocene-xylene mixture is introduced via an injecting system. The different parts of this assembly are:
1 represents the commercial coils of fiber,
2 represents the circulation area in which the fibers circulate and able to reach 4 return cycles or more,
3 represents the lock fitted with a cap and inputs and outputs provided for the fibers and the injecting of inert gas,
4 represents the oven 1,
5 represents the processed and stored coils of fibers,
6 represents the containment enclosure,
7 represents the reeling system which particularly allows for correctly winding the fibers in coils while respecting the coil pitch,
8 represents the area for injecting hydrogen and argon,
9 represents the area for injecting acetylene and argon,
10 represents the processing or synthesis area,
11 represents the syringe pump system and the tank for mixing the liquid xylene-ferrocene,
12 represents the oven
13 represents the cap,
14 represents the CVD reactor for example of quartz tube,
15 represents the device for atomizing the mixture of liquid xylene-ferrocene,
16 represents the atomized liquid,
17 represents the area for the continuous deposit of a biocompatible conductive polymer.

FIG. 3 represents the diagram of an assembly used for the synthesis of carbon nanotubes at the surface of the particles. The different parts of this assembly are:
1 represents the particles,
2 represents the oven,
3 represents the injection device by a system composed of 2 steel tubes with an inner diameter of 0.5 mm whereof one is for the liquid and the other for the gas,
4 represents the area for injecting the hydrogen and argon,
5 represents the area for injecting the acetylene and argon,
6 represents the syringe pump system and the tank of the liquid xylene-ferrocene mixture.
7 represents the CVD reactor for example of quartz tube
8 represents the caps
9 represents the output of used gas
10 represents the atomized liquid
11 represents the oven n.2.

FIG. 4 represents the mass of ferrocene in vapor form (M expressed in grams), according to the temperature of the vaporization chamber (T expressed in Kelvin degrees).

FIGS. 5a, 5b, 5d, and 5e represent the photographs of titanium dioxide particles in scanning electron microscope (SEM) in example 1, after the deposit of CNT at their surface by the method of the invention with respectively low and high magnification.

FIG. 5c is a representation of the progress of the diameter and length of the CNT according to the synthesis temperature. D, expressed in nm corresponds to the diameter of the CNT; L, expressed in μm, corresponds to the length of the CNT; T expressed in C.°, corresponds to the temperature of the synthesis by chemical vapor deposition. The rounds represent the diameter of the CNT and the triangles the length of the CNT.

FIGS. 6a and 6b represent the photographs of titanium dioxide particles in scanning electron microscope (SEM) in example 2, after the deposit of CNT at their surface by the method of the invention with respectively low and high magnification.

FIGS. 7a and 7b represent the photographs of carbon fibers in scanning electron microscope in example 3, after the deposit of CNT at their surface by the method of the invention with respectively low and high magnification.

FIGS. 8a and 8b represent the photographs of glass fibers in scanning electron microscope in example 4 after the deposit of CNT at their surface by the method of the invention with respectively high and low magnification.

FIG. 9 represents the assembly making it possible to measure the surface strength of the conductive paint of example 5. This assembly consists in two copper electrodes separated from each other by 2.6 cm and which form a square, the side of which is 2.6 cm. These two electrodes are connected to Keithley 2400 which simultaneously serves as a voltage generator and ammeter. The paint sample is deposited on a plate of glass.

FIG. 10 represents the surface strength of a paint measured according to the CNT ratio. The squares represent a conductive paint according to example 5 and the lozenges correspond to a paint solely comprising CNT. On the fig., the part I represents the area “insulating paint”; the part II represents the area “antistatic paint with a resistance R<100 M/²”; the part III represents the area “conductive paint with a resistance R<50 k/²”.

FIG. 11 represents a unidirectional ply sheet T700/M21 (carbon fibers are Toray T700 GC fibers and the matrix is an epoxy resin M21, both are provided by the Hexcel company).

FIG. 12 represents the thermal conductivity of the composite obtained in example 7 measured according to the quantity of the reinforcement (alumina particles covered with CNT) present in said material, In ordinate it is about the thermal conductivity expressed in W/mK and in abscissa it is the quantity of reinforcement expressed in percentage of weight with respect to the weight of the composite material.

### EXAMPLES

### Assemblies Used in the Method According to the Invention

The assemblies (FIGS. 1 to 3) are achieved so as to monitor the simultaneous injections of the chemical precursors and the gas flowrates in a quartz tube type reactor whereof the heating is ensured by a thermal oven with resistance available from Carbolite equipped with a temperature programmer.

The gas flowrates (acetylene (C₂H₉), argon (Ar), hydrogen (H₂)) are measured and monitored by digital mass flowmeters available from Bronkhorst France and SERV INSTRUMENTATION.

The flowrates of liquid precursors (xylene, xylene-ferrocene mixture) are monitored with a medical syringe pump type mechanism (available from Razel or Fisher Bioblock scientific) or a mixer equipped with a liquid flowmeter (available from Bronkhorst France and SERV INSTRUMENTATION).

The ferrocene may be injected dissolved into the xylene or directly vaporized and injected by convection by means of a neutral carrier gas as for example argon, thanks to an adapted device. In the examples, when ferrocene is directly vaporized, the vaporization is carried out in a glass vaporization chamber (round bottom balloon tricols 100 ml available from Fisher heated bioblock), the vaporization temperature is of 350° C.; the carrier gas is the argon with a flowrate of 0.1 to 0.4 l/min.

More generally, for the vaporization of ferrocene, a device external to the reactor or reaction chamber allows to heat the ferrocene in order to vaporize it. The vapor is thus, injected by convection: a flow of neutral gas sweeps the vaporization chamber.

For a given temperature, the quantity of vaporized ferrocene is proportional to the neutral gas flowrate. By taking into account the vapor pressure of the ferrocene in the vaporization chamber (P expressed in mm Hg), the quantity of ferrocene may be calculated by the relation (1):

Log P(mm Hg)=7.615−2470/T(° K) (1)

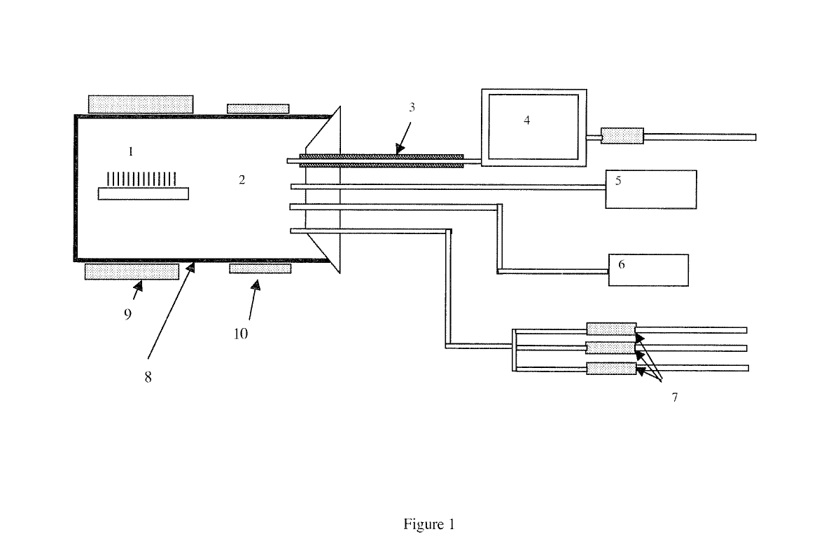

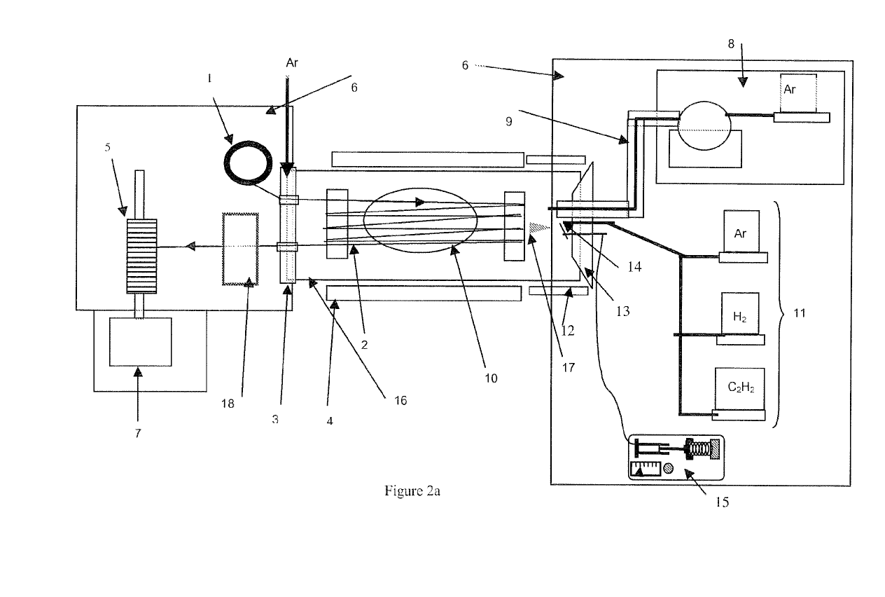

FIG. 4, represents the mass of ferrocene in vapor form (M expressed in grams), according to the temperature of the vaporization chamber (T expressed in Kelvin degrees).

With an assembly according to FIG. 1, it is possible to adapt the parameters of synthesis for each type of reinforcements: long, short and particulate reinforcements.

The synthesis of CNT on reinforcements has been studied according to the method of the invention with acetylene (C₂H₂) and xylene as carbon precursor and ferrocene as catalyst. An improvement of the method in terms of:
reproducibility of the results obtained;
homogeneity of the diameter and the density of deposited CNT (number per surface unit) which here is μm²);
decrease in the synthesis temperature at a temperature of 350 to 780° C. (instead of 650 to 850° C. in the classic methods using either acetylene or xylene);
decrease in secondary dangerous products (no or little benzene and toluene produced by the method using the xylene alone);

has been obtained.

Method of “Continuous” Synthesis of CNT on Fibers

The assemblies used for the “continuous” synthesis of nanotubes on fibers are represented in a diagram form in FIGS. 2a. and 2b.

The method achieves the synthesis of CNT (carbon nanotubes) by the method of chemical vapor deposition (CVD) in a reactor placed in an oven with a temperature ranging from 350° C. to 780° C., in which are “continuously” injected acetylene gas (C₂H₂) and xylene as a carbon source and ferrocene as catalyst.

The fibers are introduced through an orifice located at one end of the reactor, and are processed in the synthesis area, and are then stored outside the reactor, thanks to mechanisms which manage their “continuous” circulation.

An original integral mechanism comprising sets of pulleys, allows to make the fibers circulate by maximizing the quantity of fibers processed simultaneously and by extending the residence time of the fibers in the oven.

An automated system makes it possible to ensure a continuous travel speed of the fibers in the processing area (deposit of the catalyst and synthesis of carbon nanotubes). This system is composed of electrical moors controlled with electronic cards. A programme makes it possible to adapt the travel speed to obtain a satisfactory deposit and storage on the different rollers.

The gas flowrates are monitored by commercial mass flowmeters, whereas the ferrocene is injected “continuously” by an original system whereof the aim is to precisely monitor the quantity of ferrocene in aqueous phase injected “continuously”. The supply in ferrocene may also be achieved by the injection of a ferrocene-xylene solution.

Method for the Synthesis of CNT on Particles

The assembly for the method of synthesis of the CNT on particles is schematized in FIG. 3

The powder of particles to process is introduced in the oven. A mechanism carries out the stirring or alternatively another system carries out the circulation of trays containing powders for obtaining a homogenous processing.

An adapted assembly enables to simultaneously inject the liquid mixture of dissolved xylene-ferrocene and the acetylene. The liquid flowrate is monitored with a mechanism (medical type syringe pump or liquid mass flowmeter), the flow of acetylene is monitored by a digital mass flowmeter available from Bronkhorst France and SERV INSTRUMENTATION.

The flowrates of gas are monitored by commercial mass flowmeters, whereas the ferrocene is injected “continuously” by an original system whereof the aim is to precisely monitor the quantity of ferrocene in gaseous phase injected “continuously”.

### Example 1

### Method for the Synthesis of CNT on Alumina Particles (Al₂O₃)

The assembly used is that of FIG. 3.

The synthesis of CNT is carried out on the alumina particles, available from Performance Ceramics. Said particles are deposited on a quartz plate.

a) The operating conditions are the following:
internal diameter of the quartz tube used=45 mm
temperature of oven 1=780° C.
temperature of oven 2=250 to 260° C.
gas flowrate=H₂ 0.08 l/min, Ar 0.72 l/min, C₂H₂ 0.06 l/min
duration of synthesis=20 min
concentration of ferrocene in xylene: 0.01 g/ml and liquid flowrate of 12 ml/h

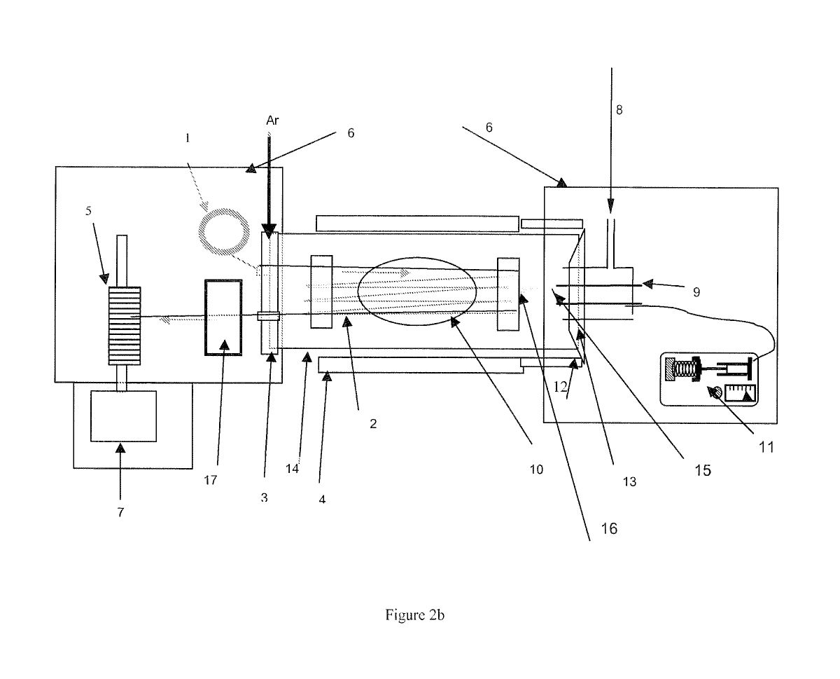

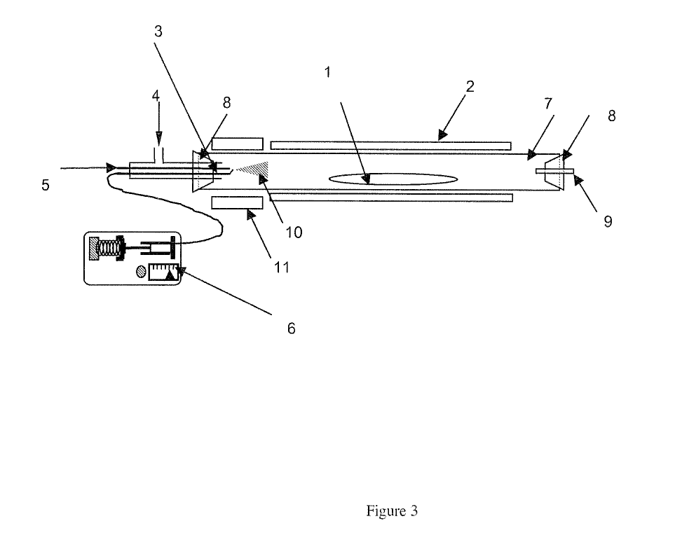

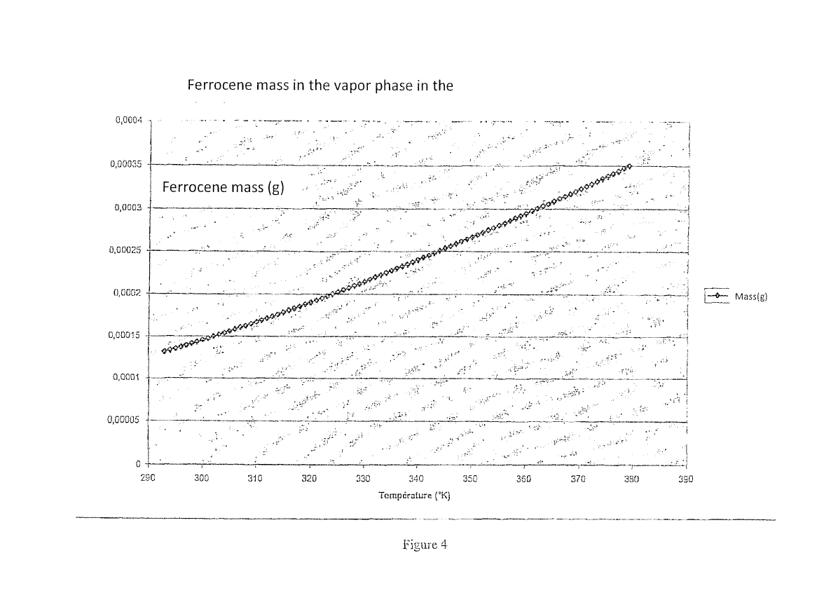

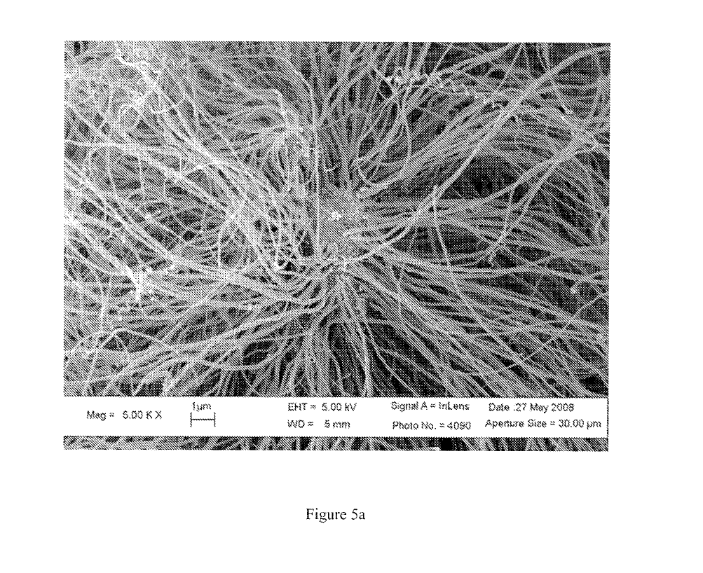

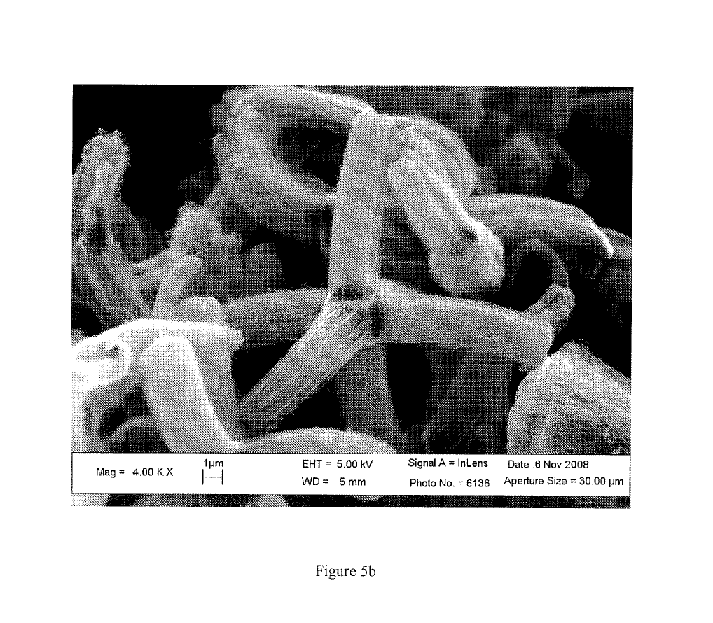

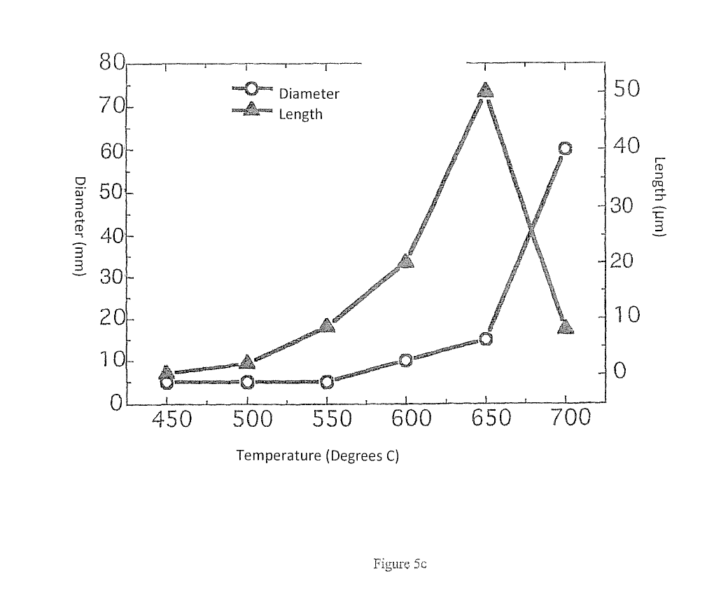

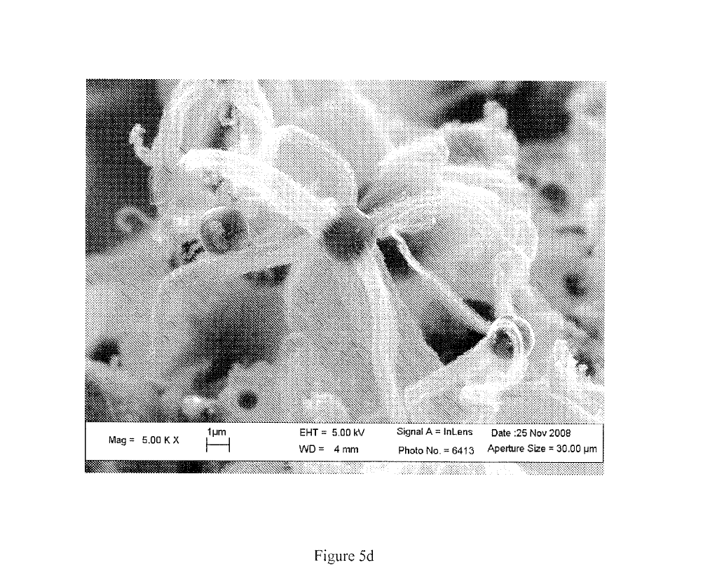

FIG. 5a represents a photograph by scanning electron microscope of alumina particles after the deposit of CNT at their surface at 780° C.

(b) The operating conditions are the following:
internal diameter of the quartz tube used=45 mm
temperature of oven 1=550° C.
temperature of oven 2=250 to 260° C.
gas flowrate=H₂ 0.11/min, Ar 0.88 l/min, C₂H₂ 0.02 l/min
duration of synthesis=15 min.
concentration of ferrocene in xylene: 0.05 g/ml and liquid flowrate of 12 ml/h

FIG. 5b represents a photograph by scanning electron microscope of alumina particles after the deposit of CNT at their surface at 550° C.

(c) The operating conditions are the following:
internal diameter of the quartz tube used=45 mm
temperature of oven 1=550° C.
temperature of oven 2=250 to 260° C.
gas flowrate=H₂ 0 l/min, Ar 0.99 l/min, C₂H₂ 0.01 l/min
duration of synthesis=15 min
concentration of ferrocene in xylene: 0.05 g/ml and liquid flowrate of 12 ml/h

FIG. 5d represents a photograph by scanning electron microscope of alumina particles after the deposit of CNT at their surface at 550° C.

(d) The operating conditions are the following:
internal diameter of the quartz tube used=95 mm
temperature of oven 1=650° C.
temperature of oven 2=250 to 260° C.
gas flowrate=H₂ 0.1 l/min, Ar 0.88 l/min, C₂H₂ 0.02 l/min
duration of synthesis=30 min
concentration of ferrocene in xylene: 0.025 g/ml and liquid flowrate of 12 ml/h

FIG. 5e represents a photograph by scanning electron microscope of alumina particles after the deposit of CNT at their surface at 650° C.

### Example 2

### Method for the Synthesis of CNT on Titanium Dioxide (TiO₂) Particles

The assembly used is that of FIG. 3.

The synthesis of CNT is carried out on the titanium dioxide particles (Tiona 595) available from Millenium of the Cristal group. Said particles are deposited on a quartz plate.

The operating conditions are the following:
internal diameter of the quartz tube used=45 mm
temperature of oven 1=700° C.
temperature of oven 2=250 to 260° C.
gas flowrate=H₂ 0.1 l/min, Ar 0.85 l/min, C₂H₂ 0.05 l/min
duration of synthesis=25 min
concentration of ferrocene in xylene: 0.05 g/ml and liquid flowrate of 12 ml/h

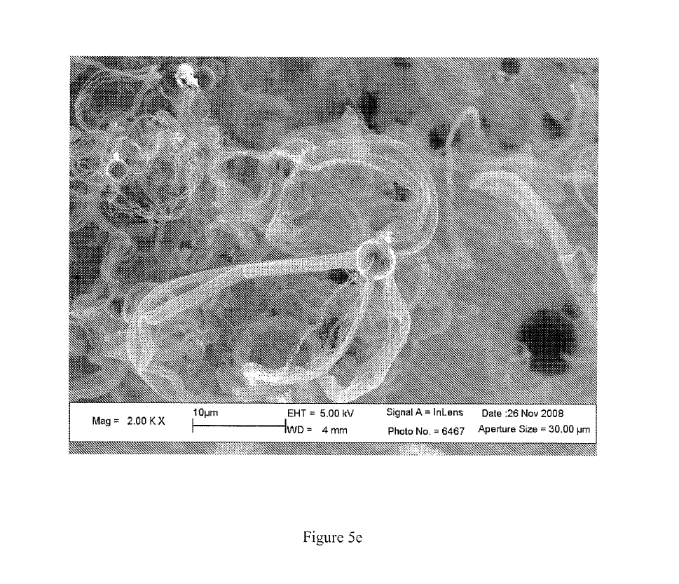

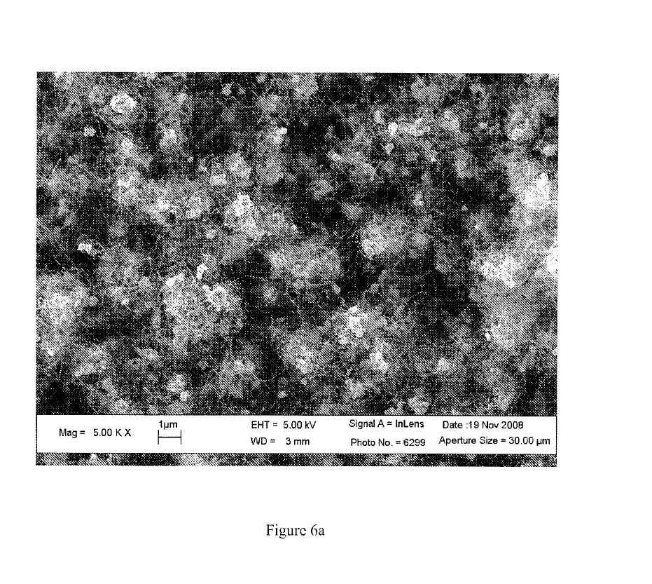

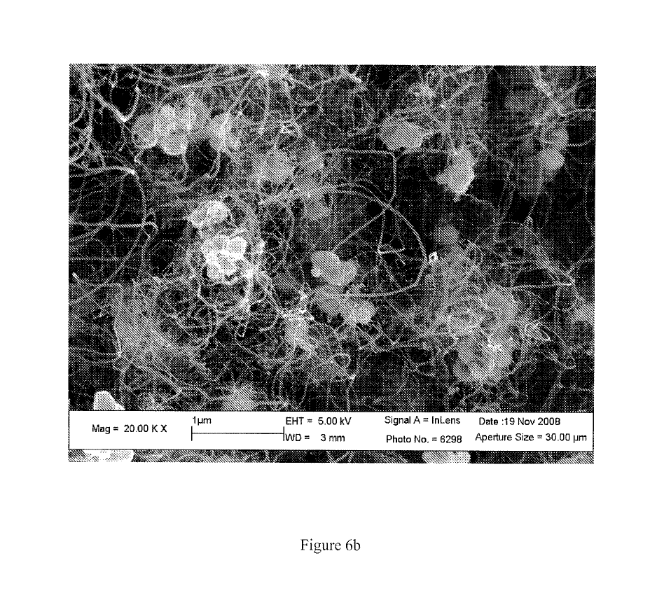

FIGS. 6a and 6b (in greater magnification) represents photographs by scanning electron microscope of titanium dioxide particles after the deposit of CNT at their surface at 700° C.

### Example 3

### Method for the Synthesis of CNT on Carbon Fibers

The synthesis is carried out “continuously” on the carbon fibers (Toray T700) by using the assembly of FIG. 2b placed in the oven and maintained by the travel mechanism

The operating conditions are the following:
internal diameter of the quartz tube used=50 mm
acetylene=0.1 l/min
hydrogen=0.1 l/min
argon=1.0 l/min
temperature of oven 1=650° C.
temperature of oven 2=250 to 260° C.
duration of synthesis=20 min
Fiber travel speed=0.15 m/min
concentration of ferrocene in xylene: 0.05 g/ml and liquid flowrate of 12 ml/h

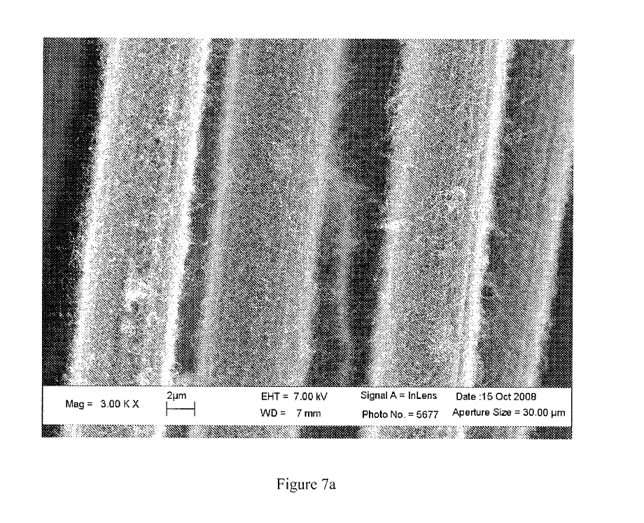

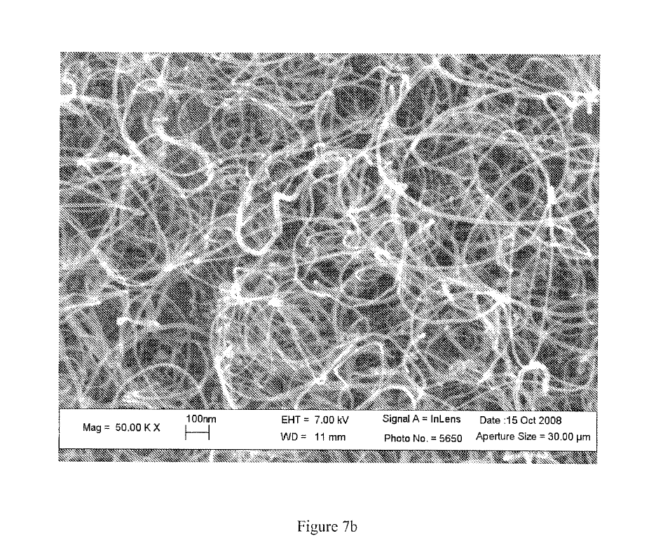

FIG. 7a represents the photograph by scanning electron microscope of carbon fibers after the deposit of CNT at their surface by the method of the invention.

FIG. 7b represents the photograph of the same carbon fibers after deposit of the CNT in greater magnification.

The fibers obtained have on their surface a number of CNT per μm² higher than 50 per μm², a mean diameter of 25 nm and a length of 10 to 20 μm.

### Example 4

### Method for the Synthesis of CNT on Glass Fibers

The synthesis is carried out “continuously” on glass fibers, available from Sinoma Science & Technology Co., Ltd., by using the assembly of FIG. 2b placed in the oven and maintained by the travel mechanism.

The operating conditions are the following:
internal diameter of the quartz tube used=50 mm
acetylene=0.5 l/min
hydrogen=0.1 l/min
argon=0.9/min
temperature of oven 1=650° C.
temperature of oven 2=250 to 260° C.
duration of synthesis=20 min
concentration of ferrocene in xylene: 0.05 g/ml and liquid flowrate of 12 ml/h

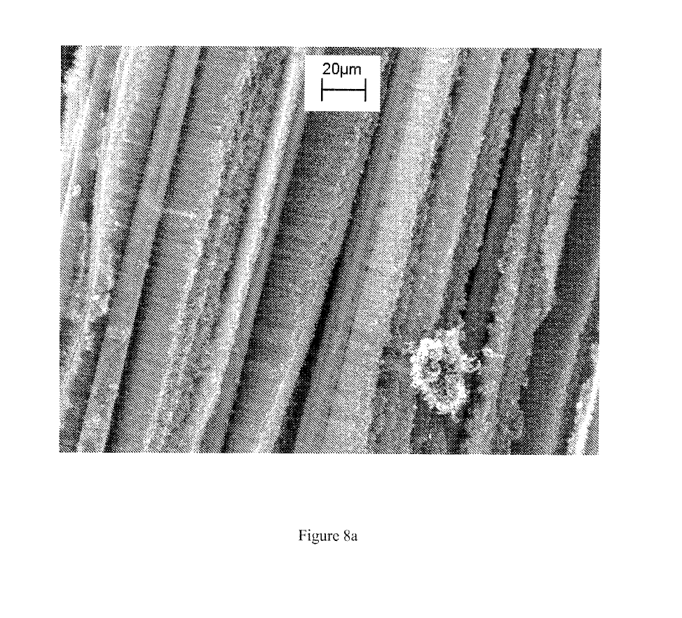

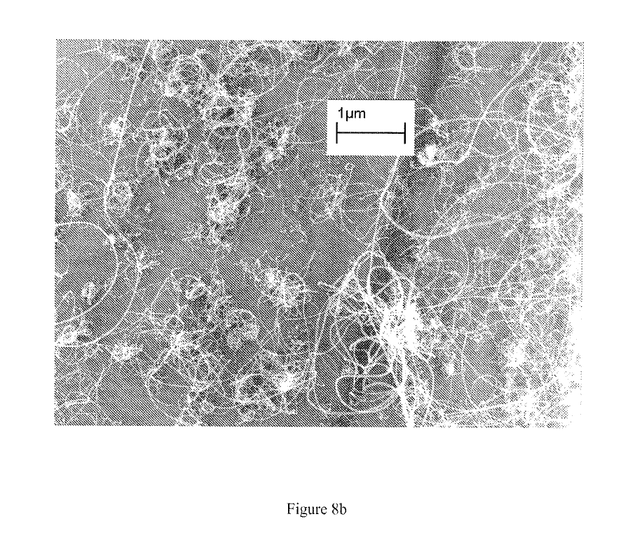

FIG. 8a represents the photograph by scanning electron microscope of glass fibers after the deposit of CNT at their surface by the method of the invention. The CNT appear to be very dense and aligned.

FIG. 8b represents the photograph of the glass fibers after deposit of the CNT in greater magnification by the method of the invention.

These different examples show that the method of the invention provides adaptation possibilities and brings an industrial interest:

1. it allows for a more reliable and more homogenous processing on the particulate reinforcements and the long fibers.

2. it makes possible the processing of fibers, without damage. It makes possible the monitoring of the structure of the layer of nanotubes and thus offers solutions for modifying the repartition of the diameters, density and the arrangement of nanotubes on the micrometric reinforcements according to the considered application.

### Example 5

### Composites: Electrical Conductive Paint Application

The aim of this example is to cause a paint to be conductive by incorporating a material according to the invention which comprises carbon nanotubes at its surface.

This type of paint may be interesting in many industrial fields such as for example in aeronautics, multimedia, medical, automobile, military, maritime, etc. In the air, the plane becomes charged with static electricity which needs to be evacuated from the tail of the plane, just like the lightening when it hits it. This evacuation is currently ensured by an economically prejudicial copper wiring of a certain weight. The replacement of this wiring by a conductive paint would enable to reduce the economic cost considerably.

The operating conditions are the following:

The paint prepared in this example is a polyurethane paint comprising a polyurethane system, a polyol base in acrylic resin (provided by MAPAERO), an isocyanate hardener RHODOCOAT X HZ D 401 (provided by MAPAERO) and a reinforcement material according to the invention.

The material used as reinforcement in this example is that prepared according to the operating mode d) of the example 1. The material has a diameter of 10 nm, a length of 60 to 70 μm and a mass increase of 47% with respect to the total mass of the resulting material (alumina+CNT)

The composition of the prepared conductive paint is the following:
Polyol base: 70 g
Hardener RHODOCOAT X EZ D 401: 16.1 g
Diluent (water): 7 g
Reinforcement according to the invention: 1.7 g

The paint is prepared by simply mixing the components indicated above at ambient T° C. (around 20° C.)

Surface Strength Measurements:

The surface strength is the measurement of the inherent strength of the surface of a material to the flow of current.

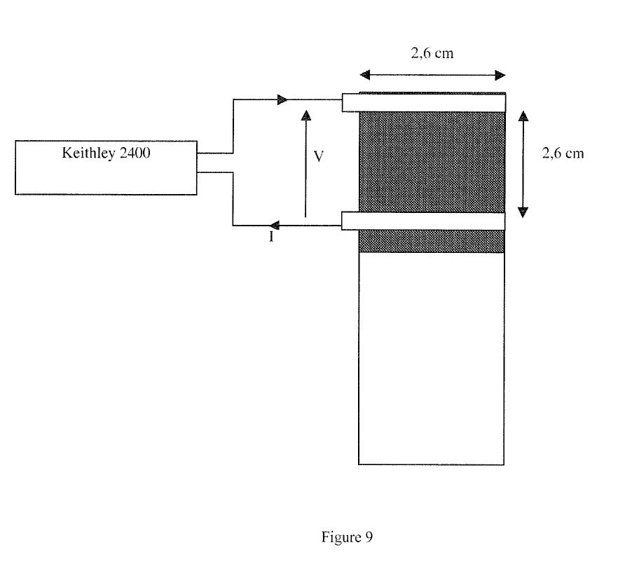

The surface strength has been measured by the assembly of FIG. 9. The assembly consists in two copper electrodes separated by 2.6 cm and which form a square, the side of which is of 2.6 cm. These two electrodes are connected to Keithley 2400 which simultaneously serves as a voltage generator and ammeter. A voltage of 210 V is applied.

Thus, a measurement of the surface strength Rs is obtained.

Results

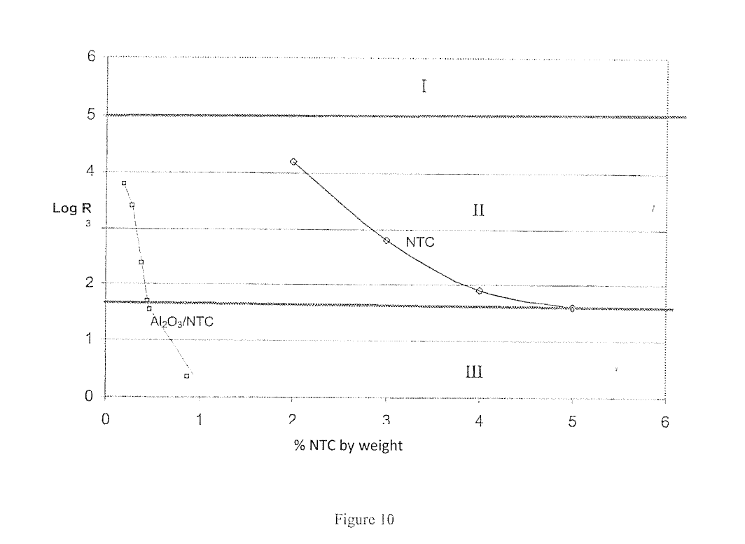

FIG. 10 shows and compares the electric surface strength of a conductive paint according to the example with a reinforcement-based paint constituted of carbon nanotubes.

The formulated polyurethane paint improves by a 10 factor the surface conductivity of the paint with respect to a paint only containing nanotubes as reinforcement. The conductivity threshold is attained at 0.5% in mass of CNT in the end paint.

### Example 6

### Composites: Structural Material Application

A structural composite material is generally constituted by a reinforcement and a matrix. The reinforcement, most of the time in a fibrous or filament form, ensures the most important of the mechanical properties.

In this example, the reinforcement used is a carbon fiber comprising CNT at its surface. The continuous synthesis of CNT on the carbon fibers is schematized on FIG. 2. From a coil of virgin carbon fibers, the synthesis of the CNT (carbon nanotubes) is achieved by the method of chemical vapor deposition (CVD) in a reactor placed in an oven at a temperature of 650° C. wherein are “continuously” injected the acetylene gas (C₂H₂) and the xylene as carbon source, and the ferrocene as catalyst.

The operating conditions are the following:
acetylene=0.1 l/min
hydrogen=0.1 l/min
argon=1.0 l/min
temperature of oven 1=650° C.
duration of synthesis=9 h
fiber travel speed=0.15 m/min
concentration of ferrocene in xylene: 0.05 g/ml and liquid flowrate of 12 ml/h.

The fibers pass in the reactor by a pulley system, then are wound on a drum of a diameter of 23 cm and a length of 25 cm, namely a unidirectional ply sheet (all the fibers are in the same direction) of 25 cm wide on 72 cm long, once unwound. The drum may be covered with a paper of epoxy resin M21 available from Hexcel.

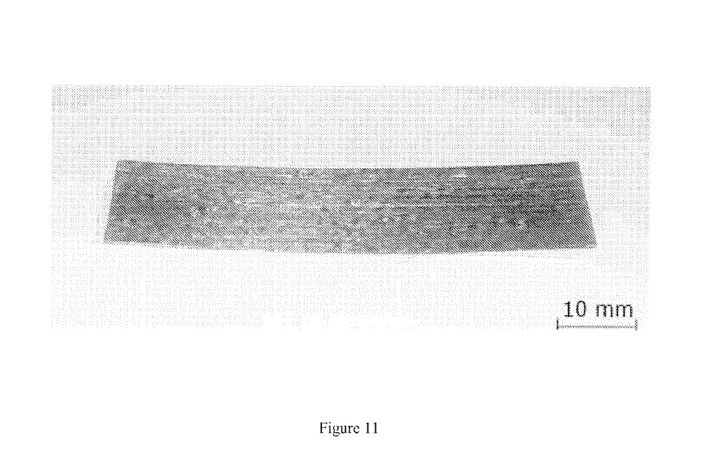

A motorized system thus enables to manufacture pre-impregnated plates of 720 mm×250 mm of composite (FIG. 11), by assembling according to the provided stacking sequences, the thus manufactured ply sheets. The cooking of the composite has been carried out according to the same cycle as the composites without nanotubes, established by the Hexcel company for this type of composite.

Results

The measurements of conductivity have been carried out with the same assembly (FIG. 9) as that used in the previous example. The measurements of conductivity carried out on plates of 8 ply sheets are summarized in the following table:

| | Strands of fibers | | Composite plates | | |
|---|---|---|---|---|---|
| Conductivity | Direction | Thick- | direction | Ply | thick- |
| (S/m) | fibers | ness | fibers | direction | ness |
| Reference | 2.7E+03 | 5.66E−04 | 2.50E+03 | 1.70E+03 | 1.07 |
| FC/CNT hybrid | 1.5E+04 | 2.1E−01 | 5.00+04 | 2.50E+04 | 9.06 |

For composite plates, “ply direction” means the width direction of the plate and “fiber direction” means the length direction of the plate (72 cm).

The mechanical characteristic for the 2 plates gives a Young's modulus d=100 GPa

The composites comprising carbon fibers coated with CNT clearly improve the conductivity of the composite without substantially modifying its mechanical properties. The mass concentration of the fibers is around 60%, that of the CNT is around 1% with respect to the total mass of the composite.

The epoxy resins comprising carbon fibers coated with CNT have good mechanical characteristics. They are generally used for the realization of structural pieces and aeronautics.

### Example 7

### Composites: Thermal Interface Materials Application

In this example, a composite material is prepared. The material used as reinforcement in this example is that prepared according to the operating mode d) of example 1. The matrix is an epoxy resin (Resoltech resin 1800, hardener Resoltech D1084, available from Resoltech, France).

The reinforcement is added in the resin 1800 in presence of a hardener D1084. The resin ratio: hardener is of 100:33. The whole is mixed manually at ambient temperature (around 20° C.)

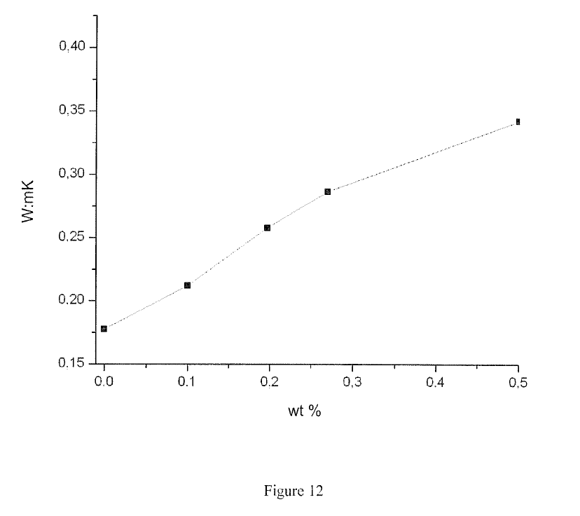

The thermal conductivity of the composite obtained is measured according to the quantity of the reinforcement (alumina-CNT) present in said material (FIG. 12.)

The thermal measurement is carried out on samples having a surface of 1 cm² and a thickness of around 1 mm. The thermal characterization is achieved with a light flash apparatus LFA 447 (of the company Netzsch-Geratebau, Germany). The light impulsion is generated by the Xenon high-performance light flash lamp placed inside the parabolic mirror. The thermal conductivity measurements are repeated 3 times on the same sample giving the conclusion of the excellent reproducibility of the measurements.

### LIST OF REFERENCES

[1] P. M. Ajayan, Chem. Rev., vol. 99, p. 1787, 1999, Nanotubes from carbon.
[2] Z-G. Zhao, L-J. Ci, H-M. Cheng, J-B. Bai, Carbon 43 (2005) 651-673; X. Gao, L. Liu, Q. Guo, J. Shi, G. Zhai, Materials Letters 59 (2005) 3062-3065; N. Sonoyama, M. Ohshita, N. Akio, H. Nishikawa, H. Yanase, J. Hayashi, T. Chiba, Carbon 44 (2006) 1754-1761.
[3] Q-J. Gong, H-J. Li, X, Wang, Q-G. Fu, Z-W. Wang, K-Z. Li, Composites Science and Technology 67 (2007) 2986-2989.
[4] H. Qian, A. Bismarck, E. S. Greenhalgh, G. Kalinka, M. S. P. Shaffer, Chem. Mater., 20 (2008), 1862-1869.

1. A method for the synthesis of carbon nanotubes on the surface of a material, comprising the following steps carried out under a stream of inert gas:
(i) heating the material in a reactor, at the surface of which the carbon nanotubes are to be synthesized, at a temperature ranging from 350° C. to 850° C.;
(ii) introducing in said reactor, a carbon source comprising acetylene and xylene, and a catalyst containing ferrocene;
(iii) exposing the heated material to the carbon source and the ferrocene-containing catalyst for a duration sufficient for obtaining carbon nanotubes at the surface of said material;
(iv) recovering the material comprising at its surface carbon nanotubes, at the end of step (iii).

2. The method according to claim 1, wherein the material in step (i) is in the form of fibers of a diameter of 1 to 100 nm, or particles with a diameter of 0.1 to 100 nm.

3. The method according to claim 2, wherein the material is in the form of long fibers with a diameter of 4 to 50 nm.

4. The method according to claim 1, wherein the synthesis method is continuous.

5. The method according to claim 1, wherein the material is selected from the group comprising:
fibers of carbon, glass, alumina, silicon carbide (SiC), rock;
ceramic materials selected from the group comprising particles and fibers of silicon nitride (Si₃N₄), boron carbide (B₄C), silicon carbide (SiC), titanium carbide (TiC), cordierite (Al₃Mg₂AlSi₅O₁₈), mullite (Al₆Si₂O₁₃), aluminium nitride (AlN), boron nitride (NB), alumina (Al₂O₃), aluminium boride (AlB₂), magnesium oxide (MgO), zinc oxide (ZnO), magnetic iron oxide (Fe₃O₄), zirconia (Zr₂O), silica (Si₂O), silica fume, CaO, La₂CuO₄, La₂NiO₄, La₂SrCuO₄, Nd₂CuO₄, TiO₂, Y₂O₃, aluminium silicates (clays).

6. The method according to claim 1 wherein in step (i) the material is heated at a temperature ranging from 400° C. to 780° C.

7. The method according to claim 1, wherein in step (ii), the acetylene is introduced in the reactor in the form of gas at a linear velocity of 5.0×10⁻⁶ to 1.0×10⁻¹ m/s.

8. The method according to claim 7, wherein in step (ii) the acetylene is introduced in an amount higher than 0 and up to 20 vol. % of the total gas.

9. The method according to claim 1, wherein in step (ii), xylene is introduced in the reactor in a liquid form mixed with ferrocene.

10. The method according to claim 9, wherein the ferrocene content in the mixture ranges between 0.001 to 0.3 g of ferrocene/ml of xylene.

11. The method according to claim 1, wherein in step (ii), the material is exposed to a carbon source and to the catalyst for 1 to 120 minutes.

12. The method according to claim 21, wherein in step (iv), the material obtained from step (iii) comprising at its surface carbon nanotubes, is recovered after cooling at a temperature of 15 to 35° C.

13. The method according to claim 20 wherein steps (i) to (iv) are performed under a stream of inert gas(es) mixed with hydrogen at a hydrogen/inert gas(es) ratio of 0/100 to 50/50.

14. A material comprising at its surface carbon nanotubes obtained by a method according to claim 1.

15. The material according to claim 14, having a mass increase ranging between 0.2 and 80% with respect to the mass of the starting material.

16. The material according to any one of claims 14, wherein the number of CNT at the surface of the material ranges between 5 and 200 per μm².

17. The material according to claim 14 having a specific surface area ranging between 150 and 2000 m²/g.

18. Method for the preparation of structural and functional composite materials comprising using a material according to claim 14 as reinforcement.

19. Method for the preparation of paints and varnishes comprising using a material accordingly to claim 14 as reinforcement.

20. The method according to claim 1 further comprising mixing hydrogen with the inert gas.

21. The method according to claim 1, further comprising a cooling step between step (iii) and step (iv).

22. The method according to claim 1, wherein in step (ii), xylene is introduced in the reaction in a liquid form.
